(19) United States
(12) Patent Application Publication
(10) Pub. No.: US 2022/0156667 A1
(43) Pub. Date: May 19, 2022

(54) SYSTEMS AND METHODS FOR FORECASTING PERFORMANCE OF ENTERPRISES ACROSS MULTIPLE DOMAINS USING MACHINE LEARNING

(71) Applicant: Accenture Global Solutions Limited, Dublin (IE)

(72) Inventor: Laurence-Lavin Bellenguez, Decatur, GA (US)

(21) Appl. No.: 17/523,759

(22) Filed: Nov. 10, 2021

Related U.S. Application Data
(60) Provisional application No. 63/114,926, filed on Nov. 17, 2020.

(51) Int. Cl. G06Q 10/06

(52) U.S. Cl. CPC G06Q 10/06375; G06Q 10/06393; G06Q 10/067

(57) ABSTRACT

Aspects of the present disclosure provide systems, methods, apparatus, and computer-readable storage media that support forecasting of enterprise performance, particularly in view of a change or transformation, using machine learning and artificial intelligence. Some aspects describe using operational data to generate a virtual model (e.g., a digital twin) of a “system” of an enterprise, such as a combination of personnel, processes, technology, and customer operations and experience. Additionally, the present disclosure describes training machine learning models to forecast performance of the enterprise's system, via forecasted key performance indicators, and output of a performance forecast to enable the enterprise to make meaningful decisions with to initiating or responding to changes to the enterprise.

### CROSS-REFERENCE TO RELATED APPLICATIONS

The present application claims the benefit of priority of U.S. Provisional Application No. 63/114,926 filed Nov. 17, 2020 and entitled “SYSTEMS AND METHODS FOR PREDICTING CUSTOMER OPERATIONS AND EXPERIENCE USING MACHINE LEARNING,” the disclosure of which is incorporated by reference herein in its entirety.

### TECHNICAL FIELD

The present disclosure relates generally to leveraging artificial intelligence and machine learning to forecast performance of enterprises. Aspects disclosed herein support modelling and predicting of enterprise system performance, including the relationship to customer operations and customer experience, based on diverse data from an enterprise.

### BACKGROUND

Enterprises and organizations are constantly adapting to new events and changes in employees, processes, and technology. For example, an enterprise may implement a transformation initiative to respond to an event, such as an employee training program or a switch to a new service provider for a portion of their technology requirements. Such a transformation initiative may result in changes to the enterprise's operational data. However, such operational data is often fragmented, siloed, and point-in-time nature, which can present challenges in analyzing the operational data to determine effects of the transformation initiative. Additionally, various applications may lack sufficient integration such that communication between applications, and the resultant operational data, may not be sufficiently similar to enable meaningful analysis. Enterprises may also have difficulty quantifying or otherwise “datifying” at least some activities of employees, leading to a lack insight into how the transformation initiative affects the employees. These difficulties, among others, present challenges in analyzing the operational data, which can make predicting key performance indicators (KPIs) during and after the transformation initiative difficult or impossible.

These difficulties are increased when the transformation initiative involves the addition (e.g., implementation) of a new process or system. Some solutions are to implement the system and then test the system and the response to the enterprise prior to putting the system into use by the enterprise. Building and testing such systems and processes are time consuming and involve significant costs. Additionally, such costs may not be recouped if the KPIs determined during testing do not justify the cost of the building and testing. As such, enterprises are typically left in the undesirable position of deciding whether to initiate transformation initiatives without understanding the potential changes to KPIs or having to invest significant time and costs into implementing systems or processes for testing that may not satisfy performance targets.

### SUMMARY

Aspects of the present disclosure provide systems, methods, apparatus, and computer-readable storage media that support forecasting of enterprise performance, particularly future performance in view of initiation of a transformation or other change, using machine learning and artificial intelligence. The forecasted enterprise performance may include multiple different domains, such as personnel (e.g., employees), customers (e.g., customer operations and customer experience), processes, and technology, both individually and across the enterprise as a whole. The systems described herein (also referred to as a “Customer Digital twin”) may enable a client to model the impact of an event to the enterprise's performance in a current state and to predict key performance indicators (KPIs) at incremental target state(s) in the future, including based on key strategy decisions and changes. The predicted KPIs may be leveraged to improve resiliency of the enterprise, perform de-risk operations and accelerate insights, unlock convergence value through mergers and acquisitions (M&A) activities, meaningfully improve customer experience, and develop new products, processes, and services which drive new revenue opportunities for the enterprise. To illustrate, a platform (e.g., a “twin platform”) may host a digital thread that is used to develop a digital twin of a client enterprise, thereby marrying distinct domains of personnel, process, and technology together for meaningful analysis and prediction purposes. This digital twin may serve as a “living model” that connects the client to operations, processes, and the underpinning technology footprint of the enterprise using analytical models of the enterprise and trained artificial intelligence/machine learning.

In some aspects, a server (or other computing device) may ingest multiple types of operational data corresponding to a system (e.g., a call center, a billing department, a manufacturing center, or the like) of the enterprise, such as application data, integration data, and infrastructure data, as non-limiting examples. The application data may be output by multiple applications and may represent activities of employees, operations performed by equipment or devices, measurements of processes, and the like. The integration data may represent communications (e.g., integration) between the various applications, such as via one or more application programming interfaces (APIs). The infrastructure data may represent infrastructure of the system, such requirements, costs, relevant KPIs, and the like. The operational data (e.g., the application data, the integration data, and the infrastructure data) may be received by the server from various data sources, such as by streaming the operational data from one or more cloud data sources. After optionally performing one or more pre-processing operations (e.g., to eliminate incomplete, irrelevant, or redundant data, to convert various different types of application data to a common format, etc.), the server may generate a virtual model of the system of the enterprise based on the application data, the integration data, and the infrastructure data. For example, the server may be configured to model the system of the enterprise by creating a digital twin thread that mirrors the system, such that the digital twin thread models the integration and relationship between the personnel, processes, and technology of the system and how various inputs drive enterprise performance. For example, the virtual model may identify portions of the operational data that act as inputs to the system and drive performance as shown by particular KPIs.

After creating the virtual model (e.g., generating model data), the server may provide the model data as training data to one or more machine learning (ML) models, such as one or more neural networks as a non-limiting example, to train the one or more machine learning models to forecast performance indicators (e.g., selected KPIs) of the system based on changes to the enterprise. As illustrative, non-limiting examples, the changes may include implementing an employee training program, increasing employee incentives, replacing one or more technology assets, modifying an operational process, merging with another enterprise or divesting a portion of the enterprise, or any other change to the enterprise that is likely to influence the selected KPIs. Once the one or more ML models are trained, a user may access a client device to make use of the modelling and forecasting capabilities of the server. For example, a user may input a target change to the enterprise, and the server may provide this state change data (e.g., based on the user input) as input data to the one or more ML models to generate one or more forecasted performance indicators, such as forecasted KPIs. The server may output a system performance forecast to the client device that includes the forecasted KPIs to provide the user with relevant information regarding the enterprise's system and forecasted performance. For example, the client device may receive the system performance forecast and display a graphical user interface (GUI) that displays information derived from the virtual model and the forecasted KPIs, thereby enabling the user to understand the relationships between people, processes, and technology with respect to the system and how the enterprise, through the system, is forecasted to react to changes. In some implementations, the GUI includes one or more suggested actions to be performed by the user, or the server may output automated instructions to automated or semi-automated systems within the enterprise to initiate performance of the one or more actions. Such actions may include changing a work schedule of personnel, updating a software component of the enterprise's system, modifying an operational procedure, or the like. In this manner, by modelling the enterprise's system using the digital twin thread and training the one or more ML models to forecast performance, the user is provided with an understanding of a current state (“as is”) of the enterprise as well as forecasting a future state (“to be”).

In a particular aspect, a method for forecasting performance of enterprises using machine learning includes receiving, by one or more processors, application data, integration data, and infrastructure data corresponding to an enterprise. The application data includes data of one or more applications of the enterprise, the integration data represents communications between the one or more applications, and the infrastructure data represents an infrastructure of a system of the enterprise. The method also includes generating, by the one or more processors, a virtual model of the system of the enterprise based on the application data, the integration data, and the infrastructure data. The method includes providing, by the one or more processors, model data corresponding to the virtual model as training data to one or more machine learning (ML) models to configure the one or more ML models to forecast performance indicators of the system of the enterprise based on changes to the enterprise. The method also includes providing, by the one or more processors, state change data as input data to the one or more ML models to generate one or more forecasted performance indicators corresponding to the system of the enterprise. The method further includes outputting, by the one or more processors, a system performance forecast that includes the one or more forecasted performance indicators.

In another particular aspect, a system for forecasting performance of enterprises using machine learning includes a memory and one or more processors communicatively coupled to the memory. The one or more processors are configured to receive application data, integration data, and infrastructure data corresponding to an enterprise. The application data includes data of one or more applications of the enterprise, the integration data represents communications between the one or more applications, and the infrastructure data represents an infrastructure of a system of the enterprise. The one or more processors are also configured to generate a virtual model of the system of the enterprise based on the application data, the integration data, and the infrastructure data. The one or more processors are configured to provide model data corresponding to the virtual model as training data to one or more ML models to configure the one or more ML models to forecast performance indicators of the system of the enterprise based on changes to the enterprise. The one or more processors are also configured to provide state change data as input data to the one or more ML models to generate one or more forecasted performance indicators corresponding to the system of the enterprise. The one or more processors are further configured to output a system performance forecast that includes the one or more forecasted performance indicators.

In another particular aspect, a non-transitory computer-readable storage medium stores instructions that, when executed by one or more processors, cause the one or more processors to perform operations for forecasting performance of enterprises using machine learning. The operations include receiving application data, integration data, and infrastructure data corresponding to an enterprise. The application data includes data of one or more applications of the enterprise, the integration data represents communications between the one or more applications, and the infrastructure data represents an infrastructure of a system of the enterprise. The operations also include generating a virtual model of the system of the enterprise based on the application data, the integration data, and the infrastructure data. The operations include providing model data corresponding to the virtual model as training data to one or more ML models to configure the one or more ML models to forecast performance indicators of the system of the enterprise based on changes to the enterprise. The operations also include providing state change data as input data to the one or more ML models to generate one or more forecasted performance indicators corresponding to the system of the enterprise. The operations further include outputting a system performance forecast that includes the one or more forecasted performance indicators.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system for forecasting performance of enterprises using machine learning according to one or more aspects;

FIG. 2 is a block diagram of another example of a system for forecasting performance of enterprises using machine learning according to one or more aspects; and

FIG. 3 is a flow diagram illustrating an example of a method for forecasting performance of enterprises using machine learning according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, apparatus, and computer-readable storage media that support forecasting of enterprise performance, particularly future performance in view of initiation of a transformation or other change, using machine learning and artificial intelligence. Enterprise performance may be forecasted in the form of key performance indicators (KPIs) that indicate an overall performance for an enterprise system that covers multiple different domains, such as personnel (e.g., employees or agents), customers, processes, and technology. Aspects disclosed herein describe modelling a system of an enterprise, such as a call center, a billing department, a manufacturing center, or the like, as a virtual model based on a variety of operational data from multiple different applications, some of which may be separately siloed or not integrated, or that may not be identified as providing relevant information for modeling the enterprise's system. The modelling may be performed using a digital twin, also referred to as a digital twin thread, that is configured to mirror the enterprise's system. Although referred to as a system, the system may also be referred to as a customer integrated system (CIS), and such terminology is meant to include a combination of multiple different devices, networks, technology, and the like, that are used to support, enable, and/or monitor one or more processes performed by personnel and devices to perform a goal of the enterprise, such as answering calls at a call center, billing customers, manufacturing items, or the like. Unlike other digital twins, which are used to mirror a particular piece of equipment, usually of manufacturing equipment, the digital twin of the present disclosure is used to mirror the intangible enterprise system (e.g., the interaction of personnel, processes, and technology and the relationship to customers, as understood through analysis of customer operations and customer experience).

In addition to modelling the enterprise's system, machine language and/or artificial intelligence may be trained using the virtual model and state data to configure the machine language and/or artificial intelligence to forecast performance indicators, such as selected KPIs, based on changes to the enterprise's system. The forecasted KPIs may be used to generate a performance forecast for the enterprise's system, such as via display of a graphical user interface (GUI) that includes information derived from the virtual model, selectable indicators representing changes to the enterprise's system, and current and forecasted KPIs. A user, such as by using a client device, may interact with one of the selectable indicators to input a potential change to the enterprise's system, and the GUI may be updated to indicate forecasted KPIs based on the indicated change. Such changes may include a variety of different changes to the enterprise's system, or the enterprise itself, such as implementing an employee training program, upgrading or replacing a particular software application, merging with another enterprise or divesting a portion of the enterprise, or the like. In some implementations, the performance forecast may include one or more suggested actions to be performed by the user, or one or more instructions may be provided to automated or semi-automated systems of the enterprise to cause performance of the actions. Thus, the forecasted KPIs (and the suggested actions in some implementations) may be leveraged to provide meaningful information that allows a user to understand the likely effects of initiating a transformation initiative (e.g., a change) to the enterprise, thereby improving resiliency of the enterprise, performing de-risk operations and accelerating insights, unlocking convergence value through mergers and acquisitions (M&A) activities, meaningfully improving customer experience, and developing new products, processes, and services which drive new revenue opportunities for the enterprise.

For years chief information officers (CIOs) and chief financial officers (CFOs) have experienced great difficulties when handling customer integrated system (CIS) and large scale customer transformation programs due to multiple issues that arise, such as: there being only a “best plan” (e.g., an untested, static plan instead of a dynamic plan incorporating multiple robust possibilities), the business case for such programs is typically neutral or negative at best, the journey to completion of the programs is long, and at the end, any impact other than what is originally expected is problematic. To solve these problems, the present disclosure provides a set of tools and services that enable not just planning, but accurate prediction of an enterprise after “go-live” (e.g., implementation of a new enterprise system or other change/transformation) and reliable predictions of the value of such a transformation program, in addition to accurate realization of that value.

To illustrate, a “Customer Digital Twin” (e.g., a platform/server) may be configured to apply data and analytics to predict customer operations and customer experience performance, as part of forecasting performance for a system of an enterprise due to a transformation program (e.g., a change to the enterprise and/or enterprise's system). The Customer Digital Twin may create a digital thread across multiple fragmented domains of the client, such as a customer domain, a business operations domain, a processes domain, and an application and integration domain, as non-limiting examples. The Customer Digital Twin may be platform agnostic, configured to operate over multiple different data dimensions, adapt to a plurality of application programming interfaces (APIs) of data sources, deploy analytical and exploratory machine learning models and algorithms to forecast future performance, and develop an enriching user experience. The Customer Digital Twin may be configured to operate as a “living model” that connects customer operations, personnel, process, and technology with respect to the enterprise's system. Some benefits of the Customer Digital Twin include understanding the impact of events on business and technology performance in a current state, understanding a target state of the enterprise's system, continuously refining predictions based on key decisions and updated data from the current enterprise ecosystem, and aligning the end state to target KPIs. The Customer Digital Twin may be configured to leverage the machine learning to provide accelerated insights, prediction (“what if”) models, dynamic and ongoing insights, or a combination thereof.

Aspects of the present disclosure may be applied to a variety of use cases in which clients initiate transformation initiatives for enterprises to respond to events. An a particular, non-limiting example, aspects disclosed herein may be applied to model and forecast performance of a call center, which may be measured through KPIs related to length of calls, incorrect routing percentage, and the like. In this example, modelling the operational performance of the call center and forecasting future performance may result in improvement to forecasted KPIs such as average handle time (AHT), full-time equivalent (FTE) headcounts, regression test window and FTE requirements, and percentage of pre-go live operations that are returned within target time period, as non-limiting examples. As another example, aspects disclosed herein may be applied to model and forecast performance of a billing department, which may be measured through KPIs such as number and types of exceptions, routing errors, quantities of particular types of undesirable bills, manual interventions into an automated process, and the like.

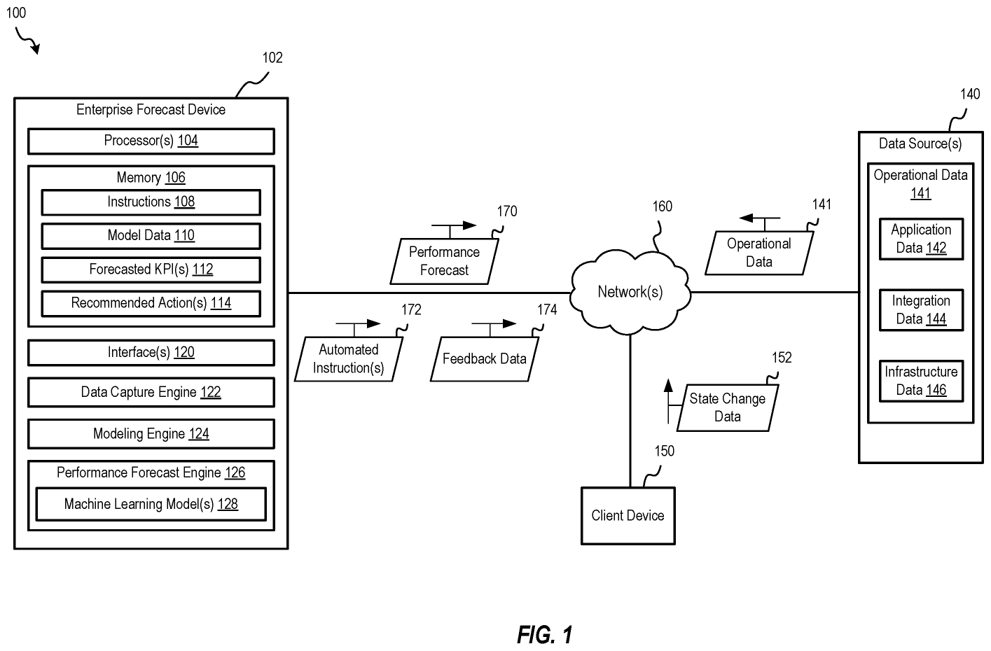

Referring to FIG. 1, an example of a system for forecasting performance of enterprises using machine learning according to one or more aspects is shown as a system 100. The system 100 may be configured to generate a virtual model of a system of an enterprise and to use trained machine learning to forecast performance for implementation of a transformation without requiring physically performing the transformation and running tests before “going live.” As shown in FIG. 1, the system 100 includes an enterprise forecast device 102, one or more data sources (referred to herein as “data sources 140), a client device 150, and one or more networks 160. In some implementations, data sources 140 or the client device 150 may be optional, or the system 100 may include additional components, such as additional client devices or additional data sources, or additional devices or systems of the enterprise, as non-limiting examples.

The enterprise forecast device 102 (e.g., a server) is configured to provide modelling and forecasting services in a distributed environment, such as a cloud-based system, as further described herein. In other implementations, the operations described with reference to the enterprise forecast device 102 may be performed by a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, a vehicle (or a component thereof), an entertainment system, other computing devices, or a combination thereof, as non-limiting examples. The enterprise forecast device 102 includes one or more processors 104, a memory 106, and one or more communication interfaces 120. It is noted that functionalities described with reference to the enterprise forecast device 102 are provided for purposes of illustration, rather than by way of limitation and that the exemplary functionalities described herein may be provided via other types of computing resource deployments. For example, in some implementations, computing resources and functionality described in connection with the enterprise forecast device 102 may be provided in a distributed system using multiple servers or other computing devices, or in a cloud-based system using computing resources and functionality provided by a cloud-based environment that is accessible over a network, such as the one of the one or more networks 160.

The one or more processors 104 may include one or more microcontrollers, application specific integrated circuits (ASICs), field programmable gate arrays (FPGAs), central processing units (CPUs) having one or more processing cores, or other circuitry and logic configured to facilitate the operations of the enterprise forecast device 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the enterprise forecast device 102 may be stored in the memory 106 as instructions 108 that, when executed by the one or more processors 104, cause the one or more processors 104 to perform the operations described herein with respect to the enterprise forecast device 102, as described in more detail below. Additionally, the memory 106 may be configured to store data and information, such as model data 110, one or more forecasted key performance indicators (KPIs) (referred to herein as “forecasted KPIs 112”), and one or more recommended actions (referred to as “recommended actions 114”). Illustrative aspects of the model data 110, the forecasted KPIs 112, and the recommended actions 114 are described in more detail below.

The one or more communication interfaces 120 may be configured to communicatively couple the enterprise forecast device 102 to the one or more networks 160 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the enterprise forecast device 102 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to the enterprise forecast device 102. In some implementations, the enterprise forecast device 102 is coupled to a display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the enterprise forecast device 102. In still other implementations, the display device is coupled to, included in, or integrated in the client device 150.

The data capture engine 122 may be configured to receive various types of operational data from the one or more data sources 140 and to ingest, process, and format the data for use by other components of the enterprise forecast device 102. For example, the various types of operational data may include data output by multiple different applications, some of which may not integrated or related, at least according to a current configuration by the enterprise. As non-limiting examples, the data capture engine 122 may be configured to receive and process data such as online transaction data, batch volume data, manual work volume data, key process configuration data, integration data, data profiles across various areas of the enterprise, infrastructure data, other application data, or a combination thereof. In some implementations, the data capture engine 122 may be configured to perform one or more pre-processing operations on the received data to standardize the received data into a common format capable of being processed downstream. For example, the pre-processing operations may include discarding incomplete, irrelevant, or duplicative data entries, converting data from multiple diverse formats into one or more common formats, condensing or otherwise dimensionally reducing data to reduce a memory footprint, other pre-processing operations, or a combination thereof.

The modeling engine 124 may be configured to generate a virtual model of the enterprise's system based on data output by the data capture engine 122. The virtual model, which may be represented by the model data 110, may model or represent the system of the enterprise in a manner that combines different domains such as personnel, processes, and technology, in view of customer operations and customer experience. As a non-limiting example, the virtual model may represent a call center of the enterprise, a billing department of the enterprise, a manufacturing center of the enterprise, or other “systems” (e.g., combinations of devices and equipment, personnel, and customer domains configured to perform a goal of the enterprise). In some implementations, the virtual model may include or correspond to a digital twin thread that is configured to mirror one or more processes corresponding to the enterprise's system and activities of one or more personnel (e.g., employees, contractors, agents, etc.) of the enterprise, contrary to other types of digital twins which are configured to mirror a particular physical apparatus, such as a particular piece of manufacturing equipment.

The performance forecast engine 126 may be configured to use machine learning to forecast system performance of the enterprise. For example, the performance forecast engine 126 may include one or more machine learning (ML) models (referred to herein as “ML models 128”) that enable forecasting of performance metrics. In some implementations, the ML models 128 may include or correspond to one or more neural networks (NNs), such as multi-layer perceptron (MLP) networks, convolutional neural networks (CNNs), recurrent neural networks (RNNs), deep neural networks (DNNs), long short-term memory (LSTM) NNs, or the like. In other implementations, the ML models 128 may be implemented as one or more other types of ML models, such as support vector machines (SVMs), decision trees, random forests, regression models, Bayesian networks (BNs), dynamic Bayesian networks (DBNs), naive Bayes (NB) models, Gaussian processes, hidden Markov models (HMMs), regression models, or the like.

To enable forecasting by the performance forecast engine 126, the ML models 128 may be trained to forecast performance indicators, such as KPIs, for the system of the enterprise using modelling data, and optionally operational data. For example, the performance forecast engine 126 may be configured to provide the model data 110, and optionally a portion or an entirety of the operational data 141, as training data to the ML models 128 to configure the ML models 128 to forecast performance indicators, such as the forecasted KPIs 112, based on input state change data that indicates a transformation (e.g., change) to the enterprise. State change data may be based on user input received by the client device 150, based on state change data selected from other sources based on one or more triggers, other state change data, or the like. In some implementations, the performance forecast engine 126 may be configured to generate additional output, such as performance forecasts (e.g., reports, GUIs, or the like, that include or are based on forecasted KPIs), recommended actions to be performed, such as the recommended actions 114, other output, or a combination thereof.

The data sources 140 are configured to store and share operational data output by multiple different applications of the enterprise. For example, the data sources 140 may be configured to store operational data 141. The data sources 140 may include one or more cloud data sources, one or more databases, one or more servers, one or more storage devices, or the like, capable of storing quantities of operational data. In some implementations, particular data sources of the data sources 140 may be configured to store only particular types of data. In some other implementations, one or more (or each) of the data sources 140 may be configured to store multiple different types of data. In some implementations, the data sources 140 may be streaming data sources configured to stream the operational data 141 to the enterprise forecast device 102.

The operational data 141 may include application data 142, integration data 144, and infrastructure data 146. In some other implementations, one or more of the application data 142, the integration data 144, or the infrastructure data 146 may not be included in the operational data 141. The application data 142 may include data output by multiple different applications, such as customer integration service (CIS) data, meter data management (MDM) data, interactive voice response (IVR) data, speech recognition data, customer care and billing (CC&B) data, supplier order management/work and asset management (SOM/WAM) data, operations management suite (OMS) data, enterprise asset management (EAM) data, data profiles, application configuration data, transaction data, batch performance data, and the like. The application data 142 may represent activities of employees, operations performed by equipment or devices, measurements of processes, and the like. The integration data 144 may represent communications (e.g., integration) between the various applications, such as via one or more application programming interfaces (APIs). The infrastructure data 146 may represent infrastructure of the system, such as requirements, costs, relevant KPIs, and the like. As additional examples, any portion of the operational data 141 may include social media profiles, influencer profiles, counts of call to utilities, internet/application/chatbot transaction volume, electronic bills, autopay profiles, consumption data, load profiles, solar power usage, electronic vehicle data, Internet of Things (IoT) enabled device data, customer demographics, and engagement and notification preferences. Additionally or alternatively, portions of the operational data 141 may include or represent counts of customers, counts of customer service representatives, employee shifts, counts of electronic customers (eCustomers), self-service transaction volume, proficiency, counts of office staff, volume of exceptions, backlog volume, referral volume, C&C volume, count of bill cycles, counts of physical bills, counts of letters, mail insert programs, bill backlog volume, counts of estimates, weather data, other information, batch process sequences and volumetrics (e.g., counts of processed records, exceptioned records, month to month performance, etc.), daily integration volumetrics, monthly integration volumetrics, or a combination thereof.

The client device 150 is configured to communicate with the enterprise forecast device 102 via the one or more networks 160 to support user interfacing and interaction with the modelling and forecasting services provided by the enterprise forecast device 102. The client device 150 may include a computing device, such as a desktop computing device, a server, a laptop computing device, a personal computing device, a tablet computing device, a mobile device (e.g., a smart phone, a tablet, a PDA, a wearable device, and the like), a VR device, an AR device, an XR device, a vehicle (or component(s) thereof), an entertainment system, other computing devices, or a combination thereof, as non-limiting examples. The client device 150 may include a processor and a memory that stores instructions that, when executed by the processor, cause the processor to perform the operations described herein, similar to the enterprise forecast device 102. The client device 150 may also include or be coupled to a display device configured to display a GUI based on a performance forecast received from the enterprise forecast device 102 and one or more I/O devices configured to enable user interaction with the GUI, as further described herein.

During operation of the system 100, the enterprise forecast device 102 may receive the operational data 141, including the application data 142, the integration data 144, and the infrastructure data 146, from the data sources 140. In some implementations, the data sources 140 may include streaming data sources, and the operational data 141 may be streamed to the enterprise forecast device 102. In other implementations, the data sources 140 may include databases, servers, cloud data sources, networked storage devices, or the like, in the cloud or network deployments, and the operational data 141 may be received via the networks 160. The data capture engine 122 may receive and ingest the operational data 141, including processing the application data 142, the integration data 144, and the infrastructure data 146 in order to prepare the operational data 141 to be used to generate a virtual model. In some implementations, the data capture engine 122 may perform one or more pre-processing operations on the operational data 141 (e.g., the application data 142, the integration data 144, the infrastructure data 146, or a combination thereof) to standardize data to represent the virtual model of the enterprise's system. For example, the pre-processing operations may include discarding portions of data (e.g., incomplete data, irrelevant data, duplicative data, erroneous data, etc.), extrapolating or otherwise estimating missing data entries, converting data from multiple different formats to a common format, dimensionally reducing or otherwise condensing data, or the like.

The data capture engine 122 may provide the ingested and processed data (e.g., based on the operational data 141) to the modeling engine 124. The modeling engine 124 may generate a virtual model of the system of the enterprise based on the data from the data capture engine 122 (e.g., the application data 142, the integration data 144, and the infrastructure data 146). For example, the modeling engine 124 may generate a virtual model, represented by the model data 110, that represents a customer integration system of the enterprise (e.g., a combination of personnel, processes, and technology with customer integration that is configured to perform a goal of the enterprise), such as a call center or a billing department, as non-limiting examples. To further illustrate, the virtual model may represent enterprise organization, technology, processes, and such across multiple different domains, such as costs to the enterprise, configurations of the system of the enterprise, customer operations, customer engagement, customer experience, other domains, or a combination thereof.

In some implementations, the virtual model includes or corresponds to, or is supported by, a digital twin thread, also referred to as a digital twin, configured to mirror one or more processes corresponding to the system of the enterprise and activities of one or more personnel (e.g., employees, agents, contractors, or the like) of the enterprise. Unlike typical digital twins that mirror physical equipment, such as manufacturing equipment, the virtual model represented by the model data 110 may represent a combination of physical devices and technology as well as processes, personnel, and customers experiences, for the enterprise. Stated another way, the digital twin thread (e.g., the virtual model) may be a “living model” that connects end customers of the enterprise to the enterprise operations, the enterprise processes, and the underpinning technology footprint of the enterprise. The digital twin thread (e.g., the virtual model) may represent a “current state” or an “as is” state of the enterprise's system (e.g., the customer integration system). Such a system may be implemented (e.g., built, configured, and/or operational) or may yet to be implemented (e.g., not built, not integrated or configured, and/or yet to go live/non-operational). In some implementations, the enterprise's system is already implemented (e.g., the technology and infrastructure is built, the applications are integrated, the processes are existing or established processes, etc.), and the application data 142, the integration data 144, and the infrastructure data 146 are generated at least partially by the implemented system. In some other implementations, the enterprise's system has yet to be implemented and the modeled processes, technology, etc., are to be implemented based on the modelling, and the application data 142, the integration data 144, and the infrastructure data 146 are generated by one or more unrelated, non-integrated, or otherwise distinct enterprise systems.

The performance forecast engine 126 may provide the model data 110 (and optionally one or more portions of the operational data 141) as training data to the ML models 128 to train the ML models 128 (e.g., to configure the ML models 128 to forecast performance indicators of the enterprise's system based on changes to the enterprise). The forecasted performance indicators may be any type of performance indicator (e.g., KPI) relevant to the enterprise, and in some implementations may be included in or indicated by the infrastructure data 146 or another portion of the operational data 141. As non-limiting examples, performance indicators (e.g., KPIs) may include customer costs to serve, at risk and energy assistance needs, revenue and defection profiles, propensity for energy efficiency (EE) programs, digital channel engagement, propensity to call, reasons for calls, exception throughput, comparisons of estimated KPIs with actual KPIs, credit collections, average handling time, count of calls on hold, length of calls before routing, counts of unsuccessful routing, counts of processed bills, duration of bill processing, backlogs, application or technology usage rates, combinations thereof, or the like. Training the ML models 128 may include providing the training data to the ML models 128 to adjust one or more parameters, providing validation data as input to the ML models 128 and, if the output of the ML models 128 fails to satisfy one or more thresholds (e.g., an accuracy threshold), further training the ML models 128. Although described herein as the enterprise forecast device 102, via the performance forecast engine 126, training the ML models 128, in other implementations, the enterprise forecast device 102 may receive trained ML model parameters that are generated by another device (of the enterprise or of a third party), and the enterprise forecast device 102 may create the ML models 128 according to the trained ML model parameters without performing any ML training operations. Alternatively, the enterprise forecast device 102, via the performance forecast engine 126, may train the ML models 128 and then the ML models 128 may be provided (e.g., as trained ML model parameters) to another device or system to be used for performance forecasting. Accordingly, the present disclosure contemplates that the enterprise forecast device 102, on behalf of the enterprise, may train and use ML models, the enterprise forecast device 102 may train ML models for use by other devices, systems, or parties without using the ML models for performance forecasting, or the enterprise forecast device 102 may receive trained ML model parameters from another source such that ML models may be used for performance forecasting without training being performed by the enterprise forecast device 102.

After the ML models 128 are trained (or otherwise configured), the performance forecast engine 126 may receive state change data 152 from the client device 150 and may provide the state change data 152 as input data to the ML models 128 to generate the forecasted KPIs 112. Generating the forecasted KPIs 112 forecasts the changes to performance of the enterprise's system in the future due to changes indicated by the state change data 152, such that the forecasted KPIs 112 represent a “future state” or a “to be” state of the enterprise's system (and/or the enterprise as a whole). To illustrate, the state change data 152 may indicate one or more changes (e.g., transformations) to the enterprise's system and/or the enterprise that may be initiated or occur and that may affect the enterprise's system. For example, the state change data 152 may represent a change in customer behavior, implementation of a new program or process by the enterprise, a merger with another enterprise, divestment of a portion of the enterprise, other changes to the enterprise's system or the enterprise, or a combination thereof. As additional, non-limiting examples, the state change data 152 may represent a change to a number of employees corresponding to the enterprise or the enterprise's system (e.g., a number of employees at a call center), a change to a shift schedule, a change to a training program, a change to an information technology (IT) system, a change to integration between one or more applications executed by the enterprise's system, a change to the one or more applications, or the like. The forecasted KPIs 112 may be any type of performance indicator that is relevant to performance of the enterprise's system. As non-limiting examples, the forecasted KPIs 112 may include average handle times, bill windows, credits and collections, billing exceptions, bills over a threshold amount, correctly routed calls, incorrectly routed calls, first call resolutions, customer reviews, quantity or rate of product manufacture, defective products, order completion time, resource usage, employee activity, revenue, enterprise reputation, or the like. As such, the performance metrics may relate to specific technology or devices used by the enterprise, activities of personnel, measurements or results of processes, customer experience or operations, enterprise-level metrics, other metrics, or a combination thereof.

In some implementations, the performance forecast engine 126 and/or the ML models 128 may also generate the recommended actions 114. The recommended actions 114 may be based on the forecasted KPIs 112, such as actions to account for forecasted decreases in performance, actions to maintain or improve forecasted improvements in performance, or the like, and may be capable of being performed by devices of the enterprise, by personnel of the enterprise, or both. For example, the recommended actions 114 may include increasing a number of employees operating the system of the enterprise during a time period, implementing an incentive program or a training program, scheduling particular operations during different time periods, modifying a batch process, other actions, or a combination thereof. The performance forecast engine 126 may output a system performance forecast that includes information related to the current state of the enterprise's system (e.g., input or operational data, current performance metrics, etc.), performance forecasts (e.g., a future state of the enterprise's system based on selected changes to the enterprise), optional recommended actions, other information, or a combination thereof. For example, the performance forecast engine 126 may output a performance forecast 170 that includes (or is based on) the forecasted KPIs 112, and optionally includes the recommended actions 114. In some implementations, the performance forecast engine 126 may output one or more instructions (referred to herein as “automated instructions 172”) to be provided to automated systems or semi-automated systems of the enterprise to cause performance of one or more of the recommended actions 114. As non-limiting examples, the automated instructions 172 may include instructions to modify a shift schedule to increase or decrease the number of personnel during particular time periods, upgrade an application or other software to a new version, purchase an additional equipment component for installation, train ML models or AI to route calls based on call type-specific resolution rates of various personnel, or the like. Additionally or alternatively, the data capture engine 122, the modeling engine 124, the performance forecast engine 126, or a combination thereof, may provide respective outputs as feedback data 174 to be provided to the enterprise's system (e.g., to the technology ecosystem, the applications, etc., responsible for generating the operational data 141). The feedback data 174 may be provided to the various applications to update and further configure the applications based on data generated by the enterprise forecast device 102, such as extrapolated or processed data output by the data capture engine 122, the model data 110 (or related information) output by the modeling engine 124, the forecasted KPIs 112 output by the performance forecast engine 126, or a combination thereof, to improve performance of the enterprise's system (e.g., to improve performance of activities performed by the personnel, to improve processes performed on behalf of the enterprise, to improve performance of the technology footprint, to improve customer experience or operations, etc.).

The client device 150 may receive the performance forecast 170 from the enterprise forecast device 102 and display a graphical user interface (GUI) to visually represent the performance forecast 170 to a user. The GUI may include one or more indicators of the information included in the performance forecast 170, such as the forecasted KPIs 112 (and optionally the recommended actions 114). Such indicators may include text, numbers, graphs, charts, diagrams, other visual elements, audio content, video content, interactive content, or a combination thereof. In some implementations, the GUI may include one or more selectable indicators configured to enable user input of one or more changes to the enterprise's system, or the enterprise itself, to trigger updates to at least a portion of the displayed information (e.g., the performance forecast 170), including at least a portion of the forecasted KPIs, the recommend actions 114, or a combination thereof. For example, the selectable indicators may include one or more popup windows, one or more dropdown menus, one or more buttons, one or more sliders, one or more dials or knobs, or the like, that enable a user to indicate changes to the enterprise through interaction with the selectable indicators. As a specific, non-limiting example, the GUI may include a slider that enables a user to select an incentive amount to be provided as part of a planned employee incentive program, and user interaction with the slider may cause one or more of the forecasted KPIs 112, the recommended actions 114, or both, to be updated based on values selected using the slider. As another example, a selectable indicator within the GUI may include a dropdown menu that enables user selection of a variety of software upgrades or new installations to be performed with respect to the enterprise's systems, and selection of any entry in the menu may cause one or more of the forecasted KPIs to be updated. To further illustrate, after displaying the GUI based on the performance forecast 170, the client device 150 may receive user input corresponding to a selectable indicator within the GUI, and the client device 150 may generate second state change data based on the user input that is provided to the enterprise forecast device 102 (or the user input may be provided to the enterprise forecast device 102 for generation of the second state change data by the enterprise forecast device 102). Responsive to receiving the second state change data, the enterprise forecast device 102 may provide the second state change data as input to the ML models 128 to cause updating of the forecasted KPIs 112 (and accordingly, the performance forecast 170), which may be provided to the client device 150 for use in updating elements of the GUI based on the change selected by the user.

As described above, the system 100 supports forecasting of performance of an enterprise's system (e.g., a representation of a combination of personnel, processes, technology, and customer operations and experience, also referred to as a customer integrated system) without requiring creation, building, or implementation of the system by the enterprise. For example, the enterprise forecast device 102 may generate a virtual model of the enterprise's system based on the operational data 141 from a variety of different applications and sources. This data may otherwise not be integrated or related by enterprise, such that analysis of the enterprise's system as a whole is not possible. Using the virtual model of the enterprise's system, which represents a current state, the ML models 128 are trained to generate the forecasted KPIs 112 based on changes to the enterprise, which represent a future state of the enterprise's system. Thus, the forecasted KPIs 112 may be leveraged to provide meaningful information that allows a user to understand the likely effects of initiating a transformation initiative (e.g., a change) to the enterprise, thereby improving resiliency of the enterprise, enabling performance of de-risk operations and accelerating insights, unlocking convergence value through mergers and acquisitions (M&A) activities, meaningfully improving customer experience, and supporting development of new products, processes, and services which drive new revenue opportunities for the enterprise.

In some aspects, the above-described techniques may be utilized in the context of improving performance of a call center of an enterprise. In such a context, the call center may be staffed by multiple employees who are responsible for answering incoming calls and routing the calls to an appropriate party capable of resolving the calls. In this example, the operational data 141 may be generated by applications executed by computing devices used by the employees to answer and route the calls, as well as to research information for routing the calls and performance of other tasks. For example, the operational data 141 (e.g., the application data 142, the integration data 144, and the infrastructure data 146) may include or represent data profiles, customer attributes (e.g., profiles, segments, billing and payment information, service order information, numbers and types of calls, etc.), process configurations, integrations (e.g., between applications, processes, etc.), batch volumes and performances, KPIs to be forecast, transactions, call volumes, call history, customer transactions, demographic data, IT system parameters, or the like. To further illustrate, the application data 142 may include CIS data and MDM data, the integration data 144 may represent communications between CIS applications or processes and MDM applications or processes, and the infrastructure data 146 may include one or more performance indicators to be forecast, such as average handling time (AHT) as a non-limiting example. This data may be processed by the data capture engine 122 and provided to the modeling engine 124 to generate a virtual model of the call center having AHT as a primary performance metric. For example, the virtual model (represented by the model data 110) may be implemented as a Customer Digital Twin that is modeled based on information such as monthly AHT by call type and by employee, historical call volumes, and the like, extracted from the operational data 141, such as due to ongoing reliability testing (ORT) performed to run queries, feed spreadsheet data, receive defect data, receive data repairs information, and implement virtual workers. The Customer Digital Twin can include an ML model built using algorithms using the attributes of the operational data 141 across various domains and dimensions, such as demographic data, customer transactions, data profiles, call history, IT systems parameters such as process configurations, integrations, batches, etc., and any parameters which have an impact on AHT. The ML models 128 may be trained to forecast AHT (and optionally other performance indicators) based on changes to the call center. To illustrate, the ML models 128 may be trained based on data profiles, transactions, call volumes, segmentation, process configurations, integrations, batch volumes, and the like, that indicate the state of the call center, and the trained ML models 128 may predict AHT for different call categories or process categories. Building and training the virtual model and the ML models 128 may include performing feature extraction, model building using training datasets, model testing using test data sets, and model fine tuning to make changes to predictors used to forecast the AHT, and this fine tuning may cause the ML models 128 to assess the impact of changes to the call center such as process enhancements, team structure improvements, integration improvements, and batch process improvements.

In some other aspects, the above-described techniques may be utilized in the context of improving performance of a call center of an enterprise without identifying particular call center systems or processes that are actually implemented at the present time. In this context, the operational data 141 may be identified as related to processes or events that result in customer calls, personnel aspects, and technology touchpoints. The processes or events that result in customer calls may be identified as billing enquiries and high bill complaints, payment arrangements and negotiations, service requests or appointments, starting/stopping/moving service scheduling, outage enquiries, emergency calls, and calls reporting theft or suspicious activity. The people aspects may include an agent team structure of the call center, number of shifts per agent, shift schedules, agent occupancy rates, agent skills/knowledge matrices, training programs, and rewards and recognition. The technology touchpoints include IT applications such as IVR, speech recognition, CC&B, MDM, SOM/WAM, and OMS, integration points between applications, data profiles, process/application configurations, transactions, and batch volumes and performance. The virtual model generated from the operational data 141 may act as a “what if” analysis, such as by modelling end to end mapping of processes which result in calls and testing changes in process steps to understand impacts to overall KPIs; testing changes to the call center such as adding more agents for process categories or specific shifts, enhancing agent skills, changing rewards/recognition for incentivizing agents, etc.; and testing changes to IT systems via application landscape rationalization, batch performance optimization, identifying and resolving integration bottlenecks, etc. Training the ML models 128 to forecast KPIs and modeling the call center in this manner enables analysis of the impact of making changes to processes, people, and technology within the call center on KPIs and enable implementation of specific changes to ensure positive outcomes. For example, continuous improvement of KPIs may be achieved through improving call volumes, a ratio of number of calls to agents, AHT, first call resolution (FCR), customer satisfaction/net promotor score (CSAT/NPS), or the like.

In some other aspects, the above-described techniques may be utilized in the context of improving performance of a billing department or billing system of an enterprise. In this context, the enterprise's system may include the processes, technology, and personnel responsible for issuing and routing bills, and the customer operations and experience correspond to the parties that receive the bills. The operations data 141 (e.g., the application data 142, the integration data 144, and the infrastructure data 146) may include or represent percentages of batch process billing, percentages of estimated readers of bills, percentages of billing exceptions, bill routing information (e.g., postal routing, e-mail routing, etc.), or the like. The virtual model may include or correspond to a digital twin that models the billing department/system by mapping simulation steps performed by the billing department/system, ingesting billing data (including complex scenarios involving net metering, community solar use, gas transportation, etc.), executing and monitoring processes, and performing impact analysis. The forecasted KPIs may include quantity of high bills, billing threshold(s), numbers of erroneous, comparisons of counts of bad estimates and good estimates, counts of repetitive exceptions, counts of complex exceptions, counts of manual interventions (e.g., to correct or successfully issue bills), counts of routing errors, counts of incorrect mailing addresses, counts of incorrect e-mail identifiers or addresses, or the like. Additionally or alternatively, the recommended actions 114 may include process improvements (e.g., ML algorithms to implement for correcting high bills, processes for correcting threshold issues, etc.), implementing robotic process automation (RPA) for executing bills in error, estimation logic revision (e.g., improvements to estimation logic configured to increase the number of good estimates based on analysis of estimation reasons), implementing RPAs with machine learning to reduce exceptions and to process exceptions without manual intervention, and initiating periodic checks of addresses and verification of e-mail identifiers based on failure counts, as non-limiting examples.

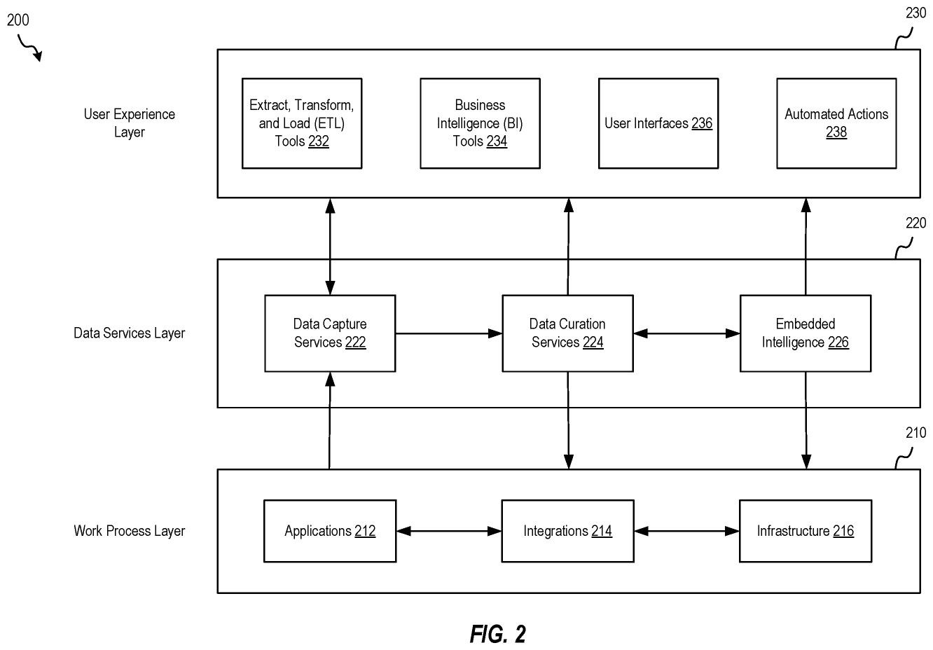

Referring to FIG. 2, an example of a system for forecasting performance of enterprises using machine learning according to one or more aspects is shown as a system 200. As shown in FIG. 2, the system 200 includes a work process layer 210, a data services layer 220, and a user experience layer 230. In some implementations, the system 200 may include or correspond to the system 100 (or components thereof). For example, the work process layer 210 may include or correspond to the data sources 140 of FIG. 1, the data services layer 220 may include or correspond to the data capture engine 122, the modeling engine 124, and the performance forecast engine 126 of FIG. 1, and the user experience layer 230 may include or correspond to the GUI displayed by the client device 150, the performance forecast 170, the forecasted KPIs 112, the recommended actions 114, the automated instructions 172, or a combination thereof.

The work process layer 210 may include applications 212, integrations 214, and infrastructure 216. The applications 212 may include multiple applications executed by computing devices of an enterprise, particularly with reference to performance of an enterprise's system (e.g., a CIS system, as described with reference to FIG. 1). The applications 212 may include related applications, unrelated applications, integrated applications, non-integrated applications, applications that are siloed for other applications, applications that are part of an enterprise's ecosystem, other applications, or a combination thereof. As a particular example, for a call center of an enterprise, the applications 212 may include CIS applications and MDM applications, as non-limiting examples. The applications 212 may be configured to track or measure activities of personnel of the enterprise, performance of processes, performance of technology, customer operations, customer experiences, other information, or a combination thereof. The integrations 214 may include or correspond to integrations that support and enable communication between the applications 212. For example, the integrations 214 may include one or more APIs corresponding to the applications 212, other technology of the enterprise, other entities accessible via one or more networks, such as via the Internet or cloud-based services, or a combination thereof. The infrastructure 216 may include or correspond to any programs, applications, routines, or the like, that establish the ecosystem in which the enterprise's system performs, that configures the relationship of the applications and other technology with the personnel, processes, and customers, and that measures or indicates performance states and performance metrics of the enterprise's system.

The data services layer 220 may include data capture services 222, data curation services 224, and embedded intelligence 226. The data capture services 222 may include or correspond to one or more applications, programs, AI or ML models, modules, devices, or the like, that receive and ingest operational data from the work process layer 210. For example, the data capture services 222 may be configured to monitor and control ingestion of internal data feeds of the enterprise, external data sets, IoT data or Industrial IoT (IIoT) data, and reusable platform adapters. The data capture services 222 may also be configured to process the received (e.g., ingested) data to aggregate and combine the data into a format that is usable by the data curation services 224. In some implementations, the data capture services 222 may be configured to perform pre-processing operations, such as eliminating erroneous, incomplete, irrelevant, or duplicative data, extrapolating or otherwise estimating missing data entries, dimensionally reducing or otherwise condensing data, converting multiple different data formats to one or more common formats, or the like. In some implementations, the data capture services 222 may include or correspond to, or perform any of the operations described with reference to, the data capture engine 122 of FIG. 1.

The data curation services 224 may include or correspond to one or more applications, programs, AI or ML models, modules, devices, or the like, that model the enterprise's system (e.g., generate a virtual model) using data output by the data capture services 222. For example, the data curation services 224 may include or correspond to a digital twin that mirrors the personnel, processes, technology, and customers of the enterprise's system. The data curation services 224 may be configured to manage the virtual model (and/or other data models), extract, transform, and load various data into the virtual model, and perform data discovery and analysis to create the virtual model. In some implementations, the data curation services 224 may include or correspond to, or perform any of the operations described with reference to, the modeling engine 124 of FIG. 1. The embedded intelligence 226 may include or correspond to one or more applications, programs, AI or ML models, modules, devices, or the like, that train and manage AI and ML models for forecasting performance of the enterprises systems. For example, the embedded intelligence 226 may include or correspond to one or more ML models, such as one or more NNs or other ML models, that are trained to forecast KPIs for the enterprise's system based on changes to the enterprise (e.g., transformations). The embedded intelligence 226 may be configured to train analytical models, AI, ML models, or a combination thereof, to forecast selected KPIs that capture the effects of changes to the enterprise such as initiating new programs, merging with another enterprise, changing a number of personnel or work shifts, upgrading applications or computing devices, or the like, as illustrative, non-limiting examples. In some implementations, the embedded intelligence 226 may include or correspond to, or perform any of the operations described with reference to, the performance forecast engine 126 and the ML models 128 of FIG. 1.

The user experience layer 230 may include extract, transform, and load (ETL) tools 232, business intelligence (BI) tools 234, user interfaces 236, and automated actions 238. The ETL tools 232 and the BI tools 234 may be configured to perform and support data analysis and business intelligence operations based on the virtual model and forecasted performance generated by the data services layer 220. The user interfaces 236 may include one or more user interfaces (UIs), such as GUIs, audio interfaces, VR interfaces, or the like, that display and communicate the virtual model and the forecasted performance of the enterprise's system to a user. For example, the user interfaces 236 may include a GUI that displays information indicating a current state of the enterprise's system, one or more forecasted KPIs, one or more recommended actions, and selectable indicators (or other interactive elements) that enable a user to input different changes (e.g., transformations) for the enterprise which cause updates of the forecasted KPIs and recommended actions based on the selected changes. The automated actions 238 may include one or more actions (e.g., the recommended actions determined based on the forecasted performance) that are performed by automated systems or semi-automated systems, as described with reference to FIG. 1.

During operation of the system 200, the data services layer 220 may receive operational data from the work process layer 210, such as application data from the applications 212, integration data from the integrations 214, and infrastructure data from the infrastructure 216. The data services layer 220 may operate as an integrated data service layer that enables capture and storage of data as the data is generated (e.g., via capture and processing by the data capture services 222), development of data pipelines to automate and aggregate the captured data, support integrated analytics and AI/ML capabilities (e.g., via the data curation services 224 and the embedded intelligence 226), and provide APIs and micro services to support flexible and focused interactions with data and insights, such as from performance forecasts. In some implementations, as the data is processed, modelled, and forecasted, output of the data curations services 224 and the embedded intelligence 226 may be passed back as feedback data to the work process layer 210, enabling data and insights to be presented to users in the context of their daily activities. Non-limiting examples of such data and insights include flagging asset issues for maintenance, engineering work prioritization, and alternative sourcing options in enterprise resource planning (ERP). The virtual model (e.g., modelling data representing the virtual model) and performance forecasts (e.g., including forecasted KPIs, recommend actions, and the like) are provided to the user experience layer 230 to enable enterprise-specific, value-oriented access to healthy and curated data, proven data modeling, and AI and ML capabilities that facilitate meaningful decision making by the enterprise, such as initiating or cancelling a proposed change, recommended actions for adapting to changes in customer operations, or replacing uncertain decisions with predictable options for future growth of the enterprise.

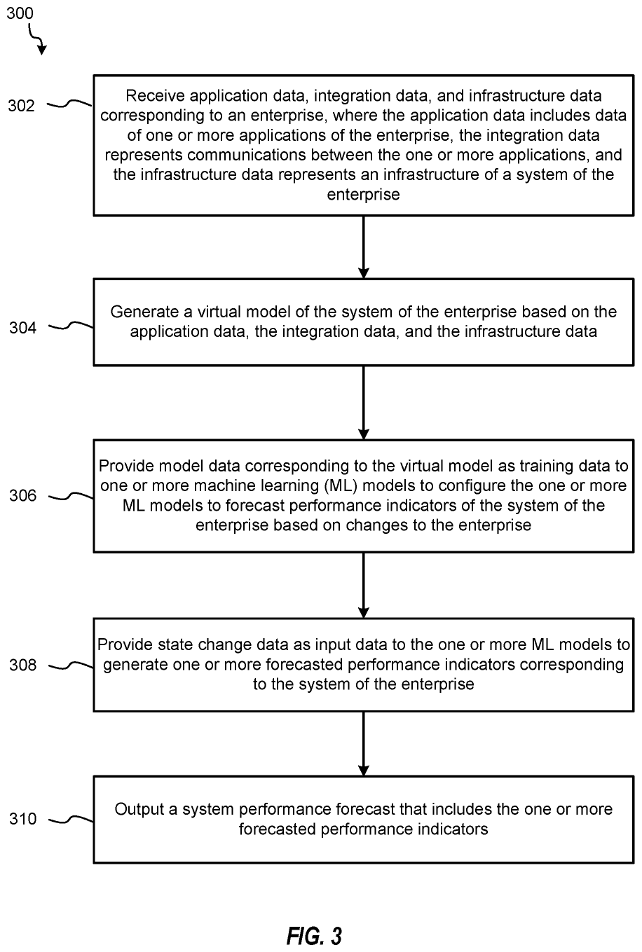

Referring to FIG. 3, a flow diagram of an example of a method for forecasting performance of enterprises using machine learning according to one or more aspects is shown as a method 300. In some implementations, the operations of the method 300 may be stored as instructions that, when executed by one or more processors (e.g., the one or more processors of a server), cause the one or more processors to perform the operations of the method 300. In some implementations, the method 300 may be performed by a computing device, such as the enterprise forecast device 102 of FIG. 1 (e.g., a server or computing device configured to forecast performance of enterprises), the system 200 of FIG. 2, or a combination thereof.

The method 300 includes receiving application data, integration data, and infrastructure data corresponding to an enterprise, at 302. The application data may include data of one or more applications of the enterprise, the integration data may represent communications between the one or more applications, and the infrastructure data may represent an infrastructure of a system of the enterprise. For example, the application data may include or correspond to the application data 142 of FIG. 1, the integration data may include or correspond to the integration data 144 of FIG. 1, and the infrastructure data may include or correspond to the infrastructure data 146 of FIG. 1. The method 300 includes generating a virtual model of the system of the enterprise based on the application data, the integration data, and the infrastructure data, at 304. For example, the virtual model of the system may include or correspond to a model represented by the model data 110 of FIG. 1. In some implementations, the virtual model may include a digital twin thread configured to mirror one or more processes corresponding to the system of the enterprise and activities of one or more employees of the enterprise.

The method 300 includes providing model data corresponding to the virtual model as training data to one or more ML models to configure the one or more ML models to forecast performance indicators of the system of the enterprise based on changes to the enterprise, at 306. For example, the one or more ML models may include or correspond to the ML models 128 of FIG. 1. The method 300 includes providing state change data as input data to the one or more ML models to generate one or more forecasted performance indicators corresponding to the system of the enterprise, at 308. For example, the state change data may include or correspond to the state change data 152 of FIG. 1, and the one or more forecasted performance indicators may include or correspond to the forecasted KPIs 112 of FIG. 1.

The method 300 includes outputting a system performance forecast that includes the one or more forecasted performance indicators, at 310. For example, the system performance forecast may include or correspond to the performance forecast 170 of FIG. 1.

In some implementations, outputting the system performance forecast includes initiating display of a GUI that includes one or more indicators of current system performance and the one or more forecasted performance indicators. In some such implementations, the GUI may include one or more selectable indicators configured to enable user input of one or more changes to the system or the enterprise to trigger updates to the one or more forecasted performance indicators. For example, the client device 150 of FIG. 1 may be configured to display a GUI based on the performance forecast 170 (which includes the forecasted KPIs 112 and, optionally, the recommended actions 114). The GUI may include selectable indicators to enable a user of the client device 150 to input changes to the enterprise, such as changes represented by the state change data 152 of FIG. 1. Additionally or alternatively, the method 300 may include initiating automatic performance of a recommended action that is based on the one or more forecasted performance indicators. For example, the enterprise forecast device 102 of FIG. 1 may provide the automated instructions 172 to an automated system or semi-automated system of the enterprise to trigger automatic performance of one or more actions based on the forecasted KPIs 112. Additionally or alternatively, the method 300 may include performing pre-processing operations on the application data, the integration data, the infrastructure data, or a combination thereof, to standardize data to represent the virtual model of the system of the enterprise. For example, pre-processing may be performed on the operational data 141 by the data capture engine 132, as described above with reference to FIG. 1.

It is noted that other types of devices and functionality may be provided according to aspects of the present disclosure and discussion of specific devices and functionality herein have been provided for purposes of illustration, rather than by way of limitation. It is noted that the operations of the method 300 of FIG. 3 may be performed in any order, or that operations of one method may be performed during performance of another method, such as the method 300 of FIG. 3 including one or more operations described with reference to other methods described herein. It is also noted that the method 300 of FIG. 3 may also include other functionality or operations consistent with the description of the operations of the system 100 of FIG. 1, the system 200 of FIG. 2, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for forecasting performance of enterprises using machine learning, the method comprising:
receiving, by one or more processors, application data, integration data, and infrastructure data corresponding to an enterprise,
wherein the application data comprises data of one or more applications of the enterprise, the integration data represents communications between the one or more applications, and the infrastructure data represents an infrastructure of a system of the enterprise;
generating, by the one or more processors, a virtual model of the system of the enterprise based on the application data, the integration data, and the infrastructure data;
providing, by the one or more processors, model data corresponding to the virtual model as training data to one or more machine learning (ML) models to configure the one or more ML models to forecast performance indicators of the system of the enterprise based on changes to the enterprise;
providing, by the one or more processors, state change data as input data to the one or more ML models to generate one or more forecasted performance indicators corresponding to the system of the enterprise; and
outputting, by the one or more processors, a system performance forecast that includes the one or more forecasted performance indicators.

2. The method of claim 1, wherein outputting the system performance forecast comprises initiating display of a graphical user interface (GUI) that includes one or more indicators of current system performance and the one or more forecasted performance indicators.

3. The method of claim 2, wherein the GUI includes one or more selectable indicators configured to enable user input of one or more changes to the system or the enterprise to trigger updates to the one or more forecasted performance indicators.

4. The method of claim 3, further comprising generating, by the one or more processors, the state change data based on user input corresponding to the one or more selectable indicators.

5. The method of claim 1, further comprising initiating, by the one or more processors, automatic performance of a recommended action that is based on the one or more forecasted performance indicators.

6. The method of claim 1, further comprising performing, by the one or more processors, pre-processing operations on the application data, the integration data, the infrastructure data, or a combination thereof, to standardize data to represent the virtual model of the system.

7. The method of claim 1, wherein:
the system of the enterprise comprises a call center;
the application data comprises customer integrated system (CIS) data and meter data management (MDM) data;
the integration data represents communications between CIS processes and MDM processes;
the infrastructure data comprises one or more performance indicators to be forecast; and
the one or more forecasted performance indicators comprise an average handling time.

8. The method of claim 7, wherein the state change data represents a change to a number of employees at the call center, a change to a shift schedule, a change to a training program, a change to an information technology (IT) system, a change to integration between the one or more applications, a change to the one or more applications, or a combination thereof.

9. The method of claim 1, wherein the state change data represents a change in customer behavior, implementation of a new program, a merger with another enterprise, divestment of a portion of the enterprise, or a combination thereof.

10. A system for forecasting performance of enterprises using machine learning, the system comprising:
a memory;
one or more processors communicatively coupled to the memory, the one or more processors configured to:
receive application data, integration data, and infrastructure data corresponding to an enterprise,
wherein the application data comprises data of one or more applications of the enterprise, the integration data represents communications between the one or more applications, and the infrastructure data represents an infrastructure of a system of the enterprise;
generate a virtual model of the system of the enterprise based on the application data, the integration data, and the infrastructure data;
provide model data corresponding to the virtual model as training data to one or more machine learning (ML) models to configure the one or more ML models to forecast performance indicators of the system of the enterprise based on changes to the enterprise;
provide state change data as input data to the one or more ML models to generate one or more forecasted performance indicators corresponding to the system of the enterprise; and
output a system performance forecast that includes the one or more forecasted performance indicators.

11. The system of claim 10, wherein the virtual model of the system comprises a digital twin thread configured to mirror one or more processes corresponding to the system and activities of one or more employees of the enterprise.

12. The system of claim 11, wherein:
the system of the enterprise is already implemented and the one or more processes are existing processes; and
the application data, the integration data, and the infrastructure data are generated at least partially by the system of the enterprise.

13. The system of claim 11, wherein:
the system of the enterprise has yet to be implemented and the one or more processes are modeled to implement the system; and
the application data, the integration data, and the infrastructure data are generated by one or more unrelated systems of the enterprise.

14. The system of claim 10, further comprising:
a network interface configured to stream the application data, the integration data, the infrastructure data, or a combination thereof, from one or more cloud data sources.

15. The system of claim 10, further comprising:
a display device configured to display a graphical user interface (GUI) that includes one or more indicators of current system performance and the one or more forecasted performance indicators.

16. The system of claim 15, wherein the GUI further includes one or more recommended actions to be performed based on the forecasted performance indicators.

17. The system of claim 16, wherein the one or more recommended actions include increasing a number of employees operating the system of the enterprise during a time period, implementing an incentive program or a training program, scheduling particular operations during different time periods, modifying a batch process, or a combination thereof.

18. A computer-readable storage medium storing instructions that, when executed by one or more processors, cause the one or more processors to perform operations for forecasting performance of enterprises using machine learning, the operations comprising:
receiving application data, integration data, and infrastructure data corresponding to an enterprise,
wherein the application data comprises data of one or more applications of the enterprise, the integration data represents communications between the one or more applications, and the infrastructure data represents an infrastructure of a system of the enterprise;
generating a virtual model of the system of the enterprise based on the application data, the integration data, and the infrastructure data;
providing model data corresponding to the virtual model as training data to one or more machine learning (ML) models to configure the one or more ML models to forecast performance indicators of the system of the enterprise based on changes to the enterprise;
providing state change data as input data to the one or more ML models to generate one or more forecasted performance indicators corresponding to the system of the enterprise; and
outputting a system performance forecast that includes the one or more forecasted performance indicators.

19. The computer-readable storage medium of claim 18, wherein the operations further comprise:
providing second state change data as additional input data to the one or more ML models to generate a second set of forecasted performance indicators corresponding to the system of the enterprise; and
updating the system performance forecast to include the second set of forecasted performance indicators.

20. The computer-readable storage medium of claim 18, wherein the operations further comprise providing the modelling data and the one or more forecasted performance indicators as feedback data to the system of the enterprise.
